(19) United States
(12) Patent Application Publication
(10) Pub. No.: US 2013/0224392 A1
(43) Pub. Date: Aug. 29, 2013

(54) METHOD FOR PROVIDING A COATING LAYER WITH PROTECTION AND THERMAL CONDUCTIVITY

(71) Applicants: Wei-Tien HSIAO, Hsinchu County (TW); Mao-Shin Liu, Hsinchu City (TW); Wu-Han Liu, Miaoli County (TW); Ming-Sheng Leu, Hsinchu County (TW)

(72) Inventors: Wei-Tien HSIAO, Hsinchu County (TW); Mao-Shin Liu, Hsinchu City (TW); Wu-Han Liu, Miaoli County (TW); Ming-Sheng Leu, Hsinchu County (TW)

(21) Appl. No.: 13/465,344

(22) Filed: May 7, 2012

(30) Foreign Application Priority Data
Feb. 23, 2012 (TW) 101105951

(51) Int. Cl. B05D 1/12; B05D 7/14; B05D 7/02; B05D 1/08

(52) U.S. Cl. 427/446; 427/180

(57) ABSTRACT

A method for providing a coating layer with well protection and thermal conductivity, providing a coating layer material, the coating layer material set on a workpiece to form a coating layer with thickness 160˜500 micrometer. The coating layer is able to avoid wear of the surface of the workpiece, and has well protection and thermal conductivity, to avoid the situation of damage or mechanical property changing occurred due to the temperature of the surface rising caused by the friction.

### TECHNICAL FIELD

The present disclosure relates to a method for providing a coating layer with well protection and thermal conductivity, and more particularly, to a method for forming a coating on a workpiece.

### TECHNICAL BACKGROUND

Operationally, modem wheel rims that are generated used on wheeled vehicles are constantly working under rough condition as the wheeled vehicles are designed to meet the challenge of bad weather, treacherous terrain. Nevertheless, due to lacking the consideration of surface protection and heat dissipation in design, most wheel rims that are currently available on the market can easily be damaged in operation by regional abrasion or by abnormal temperature fluctuations. Not to mention that a wheel rim without any protective coating can be vulnerable to and easily be eroded or corroded by environmental factors, such as rainfall and direct sunlight.

Although there are already a variety of coatings available, there is still none designed for and applied on wheel rims. Thus, beside for the means for forming a coating on a wheel rim, there are many to be improved in the porosity, microhardness, bonding strength and wear volume loss relating to the coatings that are currently available.

### TECHNICAL SUMMARY

The present disclosure relates to a method for providing a coating layer with well protection and thermal conductivity, being basically a method for forming a coating with satisfactory porosity, microhardness, bonding strength and wear volume loss on a workpiece for improving the surface protection and heat dissipation of the workpiece.

In an embodiment, the present disclosure provides a method for providing a coating layer with protection and thermal conductivity, comprising the steps of:
providing a feedstock material; and
depositing the feedstock material on a workpiece into a coating layer with a thickness ranged between 160˜500 micrometer.

The coating layer achieved by the abovementioned exemplary method is featuring in that: the porosity, microhardness, bonding strength and wear volume loss of the coating layer are improved, and by the setting of the coating layer on a workpiece, both the surface protection and thermal conductivity of the workpiece are enhanced.

Moreover, in a condition when the workpiece is substantially a wheel rim, the coating layer on the wheel rim can protect the same from being damaged in operation by regional abrasion or by abnormal temperature fluctuations. Thereby, the wheel rim with the coating layer is protected from being eroded or corroded by environmental factors, such as rainfall and direct sunlight.

In addition, not only the coating layer can protect the surface of the workpiece from being damaged by any friction or collision happening on the surface of the workpiece, but also by the thermal conductivity of the coating layer, any regional abnormal temperature fluctuation on the surface of the workpiece can be dissipated rapidly for preventing the workpiece from being damaged thereby and thus maintaining the mechanical properties of the workpiece unchanged.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a flow chart depicting the steps in a method for providing a coating layer with protection and thermal conductivity according to an exemplary embodiment of the present disclosure.

FIG. 2 is a cross sectional view of a workpiece used in the present disclosure.

FIG. 3 is a cross sectional view of a wheel rim, being used as a workpiece in the present disclosure.

FIG. 4 is a diagram showing the porosity achievable in a coating layer of the present disclosure.

FIG. 5 is a diagram showing the microhardness achievable in a coating layer of the present disclosure.

FIG. 6 is a diagram showing the bonding strength achievable in a coating layer of the present disclosure.

FIG. 7 is a diagram showing the wear volume loss achievable in a coating layer of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

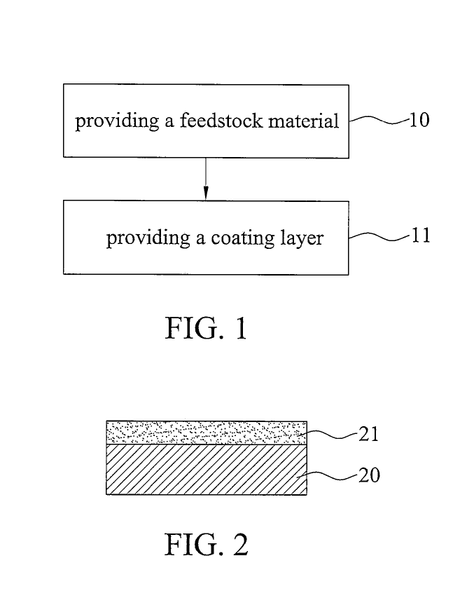

Please refer to FIG. 1, which is a flow chart depicting the steps perform in a method for providing a coating layer with protection and thermal conductivity according to an exemplary embodiment of the present disclosure. As shown in FIG. 1. the method starts from step 10. At the step 10, a feedstock material, which can be a cermet powder or a sintering powder, is provided; and then the flow proceeds to step 11. In an embodiment, the feedstock material is substantially a cermet powder, whereas the cermet powder can be a mixed powder of a ceramic powder with a metal coating and a metal powder, in which the ceramic powder can be made of a material selected from the group consisting of: aluminum oxide, titanium oxide, chromium oxide, titanium carbide, boron carbide, chromium carbide, silicon carbide, aluminum nitride, titanium nitride, boron nitride, titanium boride and the combinations of at least two forgoing materials. In a boarder picture, the ceramic powder is made of a material selected from the group consisting of: an oxide, a carbide, a nitride, a boride and the combinations of at least two forgoing materials. In addition, the metal coating is deposited onto the ceramic powder by a means of electroless plating, whereas the metal to be used for forming the metal coating can be a metal selected from the group consisting of: cobalt, nickel and aluminum. Furthermore, in this embodiment, the metal powder is made of a metal selected from the group consisting of: a aluminum powder, a aluminum alloy powder, a molybdenum powder, a molybdenum alloy powder, a tungsten powder, a tungsten alloy powder, a cobalt powder, a cobalt alloy powder, a nickel powder, a nickel alloy powder, an iron powder, an iron alloy powder, a niobium powder, a niobium alloy powder, a yttrium powder, a yttrium alloy powder, a nickel chromium powder, a nickel chromium alloy powder, a nickel chromium aluminum powder, a nickel chromium aluminum alloy powder, a cobalt chromium aluminum yttrium powder, a cobalt chromium aluminum yttrium alloy powder, a nickel chromium aluminum yttrium powder, a nickel chromium aluminum yttrium alloy powder, and the combinations of at least two forgoing materials.

In another embodiment when the feedstock material is substantially a sintering powder, the sintering powder is prepared and formed by a process comprising the steps of: mixing a ceramic powder with metal coating, a metal powder and a bonding agent so as to form a mud-like mixture; and granulating and sintering the mud-like mixture in a vacuumed environment at a temperature ranged between 900° C. to 1100° C. so as to improve the bonding strength between the metal powder and the ceramic powder and thus form the sintering powder.

At step 11, the feedstock material is coated onto a workpiece 20 into a coating layer 21 with a thickness ranged between 160˜500 micrometer, as shown in FIG. 2. It is noted that the workpiece 20 can be a metal substrate or a ceramic substrate, and the feedstock material can be coated to the workpiece by a spraying process, whereas the spraying process is a process selected from the group consisting of: a powder coating process, a n arc spraying process, frame spraying process, a plasma thermal spraying process and a high velocity oxy-fuel (HVOF) process.

In an embodiment when a HVOF process is selected for spraying the coating layer 21, it is common to choose the cobalt chromium aluminum yttrium powder to be used as the metal powder in the feedstock material which is accounted for about 90 percent of the whole feedstock material; and the ceramic powder which is accounted for about 10 percent of the feedstock material should has a particle size ranged between 50 μm and 70 μm, and with 99% purity. In addition, the flow gas flow rate for the HVOF process should be controlled within the range of 20 l/min to 100 l/min, the oxygen flow rate of the same should be controlled within the range of 300 l/min to 500 l/min, and the carrier gas flow rate of the same should be controlled within the range of 10 l/min to 50 l/min.

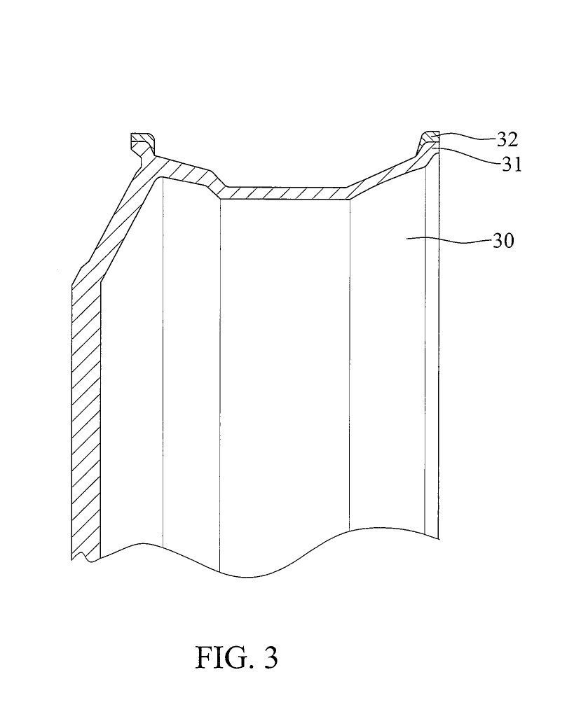

Please refer to FIG. 3, which is a cross sectional view of a wheel rim, being used as a workpiece in the present disclosure. In this embodiment, the method for forming a coating layer is basically unchanged, but is different in that: the workpiece is a wheel rim 30 instead of the aforesaid metal or ceramic substrate, and accordingly, the coating layer 32 is formed on the surface relating to the two flanges of the wheel rim 30 at a thickness ranged between 160˜500 micrometer. Moreover, the wheel rim 30 can be made of a metallic material or a polymer material, whereas the metallic material is a material selected from the group consisting of: aluminum, an aluminum alloy, iron, and an iron alloy; and the polymer material is a material selected from the group consisting of: a plastic, rubber and a kind of fiber.

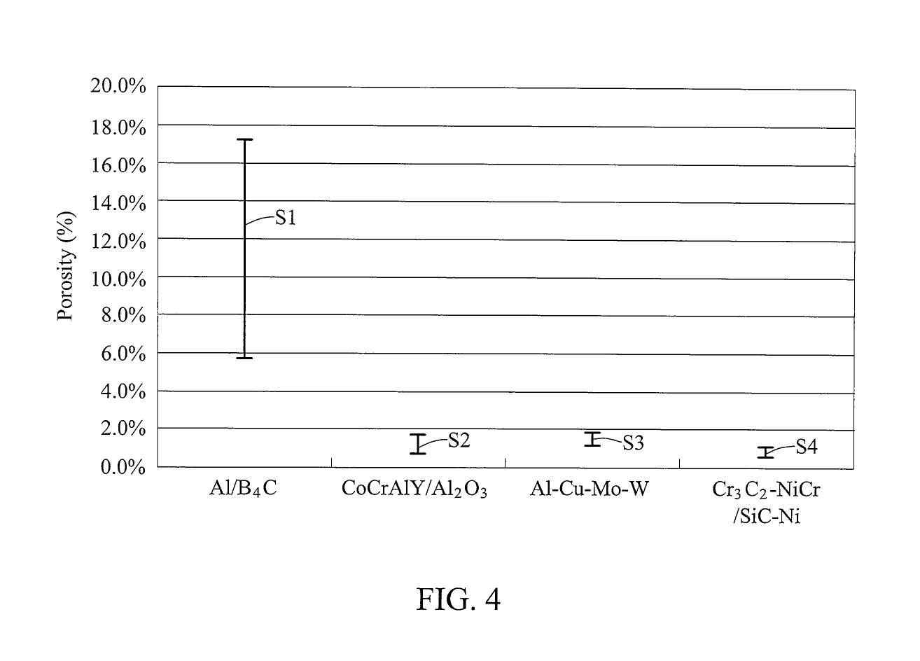

Please refer to FIG. 4 to FIG. 7, which are diagrams respectively showing the porosity, the microhardness, the bonding strength, and the wear volume loss that are achievable in a coating layer of the present disclosure. In FIG. 4 to FIG. 7, S1 represents an Al/B₄C coating layer, S2 represents a Co—Cr—Al—Y/Al₂O₃ coating layer, S3 represents an Al—Cu—Mo—W coating layer, and S4 represents a Cr₃C₂—NiCr/SiC—Ni coating layer.

As shown in FIG. 4, the porosity of SI is in a range of 6%˜17.8%, while the porosities of S2 and S3 can be lowered to 2%, whereas the porosity is a measure of the void (i.e., “empty”) spaces in the coating layer, and is a fraction of the volume of voids over the total volume of the coating layer.

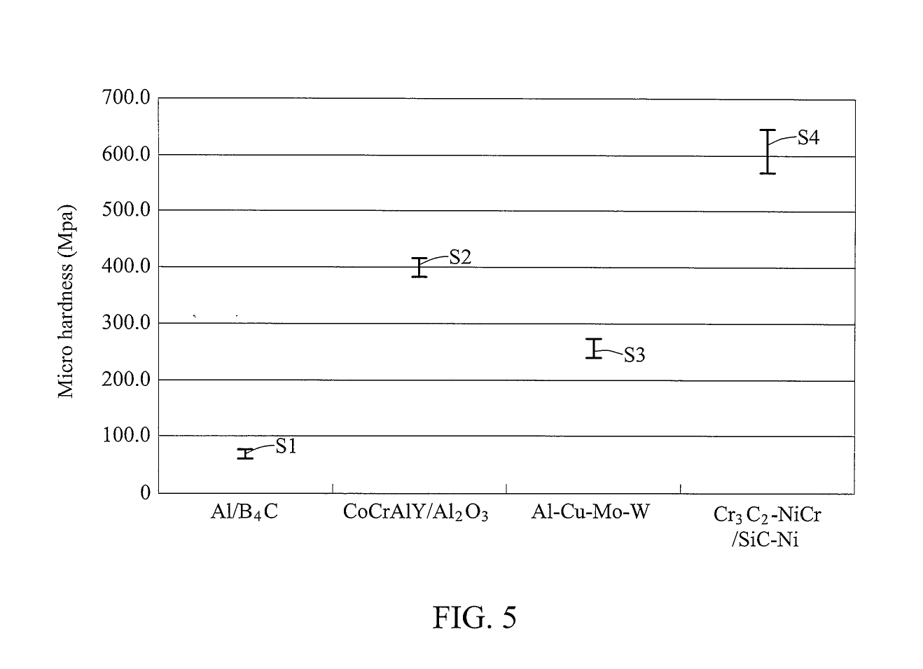

As the result of a Vickers hardness test shown in FIG. 5, the microhardness of S1 is lower than 100 Mpa, the microhardness of S2 is ranged between 300 Mpa and 200 Mpa, the microhardness of S3 is ranged between 200 Mpa and 300 Mpa, and the microhardness of S4 is ranged between 500 Mpa and 700 Mpa.

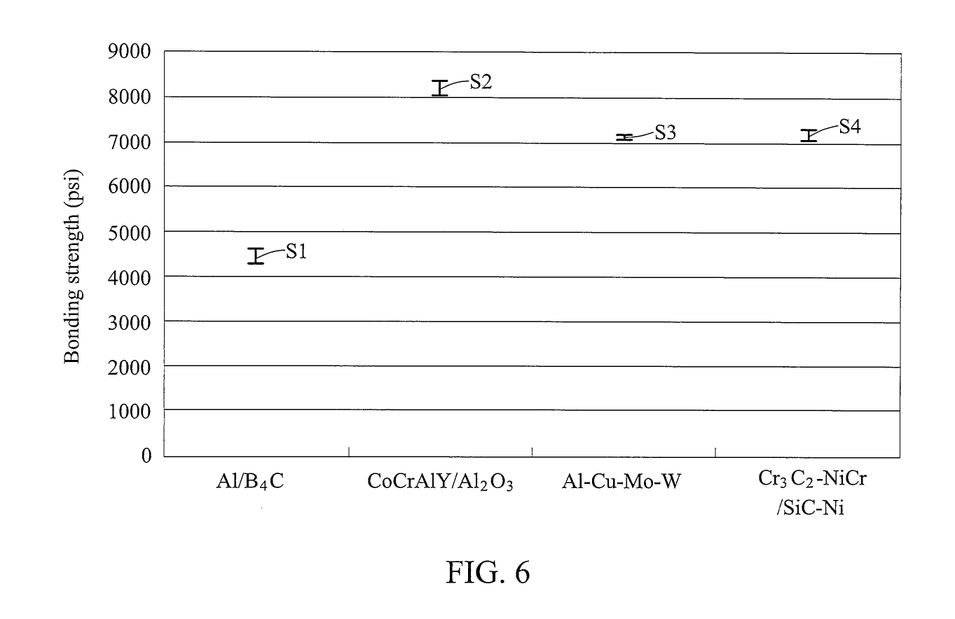

As shown in FIG. 6, the bonding strength of S1 is ranged between 4000 psi and 5000 psi, the bonding strength of S2 is ranged between 8000 psi and 9000 psi, and the bonding strength of S3 and S4 are respectively ranged between 7000 psi and 8000 psi.

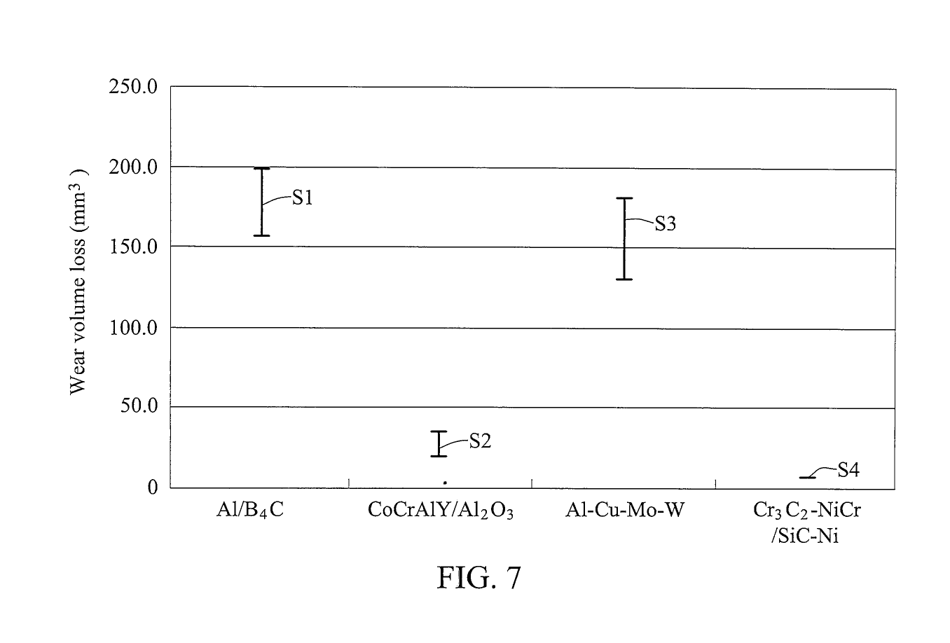

As shown in FIG. 7, the wear volume loss of S1 is ranged between 160 mm³ and 200 mm³, the wear volume loss of S2 and S4 are respectively ranged between 0 mm³ and 50 mm³, and the wear volume loss of S4 is ranged between 100 mm³ and 170 mm³.

As the characteristic values disclosed in FIG. 4 to FIG. 7, it is obvious that the coating layer of the present disclosure can perform better than other coating layer currently available in porosity, in microhardness, in bonding strength and in wear volume loess. Moreover, in a thermal conductivity test, it is realized that by the addition of silicon carbide into Cr₃C₂, the thermal conductivity of the resulting coating layer can be increased from 45.88 W/mK to 70.8 W/mK.

To sum up, the present disclosure provides a method for forming a coating layer on a workpiece using a feedstock material with better surface protection and thermal conductivity. Thereby, the coating layer can protect the operating workpiece from being damaged by regional abrasion, and also is capable of conducting heat out of the workpiece so as to be dissipated for preventing the workpiece from being damaged by abnormal temperature fluctuations.

Taking a wheel rim for instance, it is known that an operating wheel rim without the coating layer of the present disclosure can easily be damaged by regional abrasion or by abnormal temperature fluctuations, but by the coating layer with improved porosity, microhardness, bonding strength and wear volume loss, not only the wheel rim is protected from any region abrasion, but also the heat that is generated in the operation of the wheel rim can be conducted out of the same so as to be dissipated. Moreover, a wheel rim with the coating is protected from being eroded or corroded by environmental factors, such as rainfall and direct sunlight.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for providing a coating layer with well protection and thermal conductivity, comprising the steps of:
providing a feedstock material; and
the feedstock material is deposited on a workpiece into a coating layer with a thickness ranged between 160˜500 micrometer.

2. The method of claim 1, wherein the feedstock material is substantially a cermet powder.

3. The method of claim 2, wherein the cermet powder is substantially a mixed powder of a ceramic powder with a metal coating and a metal powder.

4. The method of claim 3, wherein the ceramic powder is made of a material selected from the group consisting of: an oxide, a carbide, a nitride, a boride and the combinations of at least two forgoing materials.

5. The method of claim 4, wherein the ceramic powder is made of a material selected from the group consisting of: aluminum oxide, titanium oxide, chromium oxide, titanium carbide, boron carbide, chromium carbide, silicon carbide, aluminum nitride, titanium nitride, boron nitride, titanium boride and the combinations of at least two forgoing materials.

6. The method of claim 3, wherein the metal coating of the ceramic powder is made of a material consisting of: cobalt, nickel and aluminum.

7. The method of claim 6, wherein the metal coating is deposited onto the ceramic powder by a means of electroless plating.

8. The method of claim 3, wherein the metal powder is made of a metal selected from the group consisting of: a aluminum powder, a aluminum alloy powder, a molybdenum powder, a molybdenum alloy powder, a tungsten powder, a tungsten alloy powder, a cobalt powder, a cobalt alloy powder, a nickel powder, a nickel alloy powder, an iron powder, an iron alloy powder, a niobium powder, a niobium alloy powder, a yttrium powder, a yttrium alloy powder, a nickel chromium powder, a nickel chromium alloy powder, a nickel chromium aluminum powder, a nickel chromium aluminum alloy powder, a cobalt chromium aluminum yttrium powder, a cobalt chromium aluminum yttrium alloy powder, a nickel chromium aluminum yttrium powder, a nickel chromium aluminum yttrium alloy powder, and the combinations of at least two forgoing materials.

9. The method of claim 2, wherein the feedstock material is substantially a sintering powder.

10. The method of claim 9, wherein the sintering powder is formed by a process comprising the steps of:
mixing a ceramic powder with metal coating, a metal powder and a bonding agent so as to form a mud-like mixture; and
granulating and sintering the mud-like mixture into the sintering powder.

11. The method of claim 10, wherein the ceramic powder is made of a material selected from the group consisting of: an oxide, a carbide, a nitride, a boride and the combinations of at least two forgoing materials.

12. The method of claim 11, wherein the ceramic powder is made of a material selected from the group consisting of: aluminum oxide, titanium oxide, chromium oxide, titanium carbide, boron carbide, chromium carbide, silicon carbide, aluminum nitride, titanium nitride, boron nitride, titanium boride and the combinations of at least two forgoing materials.

13. The method of claim 10, wherein the metal coating of the ceramic powder is made of a material consisting of: cobalt, nickel and aluminum.

14. The method of claim 13, wherein the metal coating is deposited onto the ceramic powder by a means of electroless plating.

15. The method of claim 1, wherein the metal powder is made of a metal selected from the group consisting of: a aluminum powder, a aluminum alloy powder, a molybdenum powder, a molybdenum alloy powder, a tungsten powder, a tungsten alloy powder, a cobalt powder, a cobalt alloy powder, a nickel powder, a nickel alloy powder, an iron powder, an iron alloy powder, a niobium powder, a niobium alloy powder, a yttrium powder, a yttrium alloy powder, a nickel chromium powder, a nickel chromium alloy powder, a nickel chromium aluminum powder, a nickel chromium aluminum alloy powder, a cobalt chromium aluminum yttrium powder, a cobalt chromium aluminum yttrium alloy powder, a nickel chromium aluminum yttrium powder, a nickel chromium aluminum yttrium alloy powder, and the combinations of at least two forgoing materials.

16. The method of claim 1, wherein the workpiece is an object selected from the group consisting of: a metal substrate and a ceramic substrate.

17. The method of claim 1, wherein the workpiece is substantially a wheel rim.

18. The method of claim 17, wherein the coating layer is formed on two flanges of the wheel rim.

19. The method of claim 17, wherein the wheel rim is made of a material selected from the group consisting of: a metallic material and a polymer material.

20. The method of claim 19, wherein the metallic material is a material selected from the group consisting of: aluminum, an aluminum alloy, iron, and an iron alloy.

21. The method of claim 19, wherein the polymer material is a material selected from the group consisting of: a plastic, rubber and a kind of fiber.

22. The method of claim 1, wherein the feedstock material is attached to the workpiece by a spraying process.

23. The method of claim 22, wherein the spraying process is a process selected from the group consisting of: a powder coating process, a n arc spraying process, frame spraying process, a plasma thermal spraying process and a high velocity oxy-fuel (HVOF) process.
